(19) United States
(12) Patent Application Publication
(10) Pub. No.: US 2025/0238842 A1
(43) Pub. Date: Jul. 24, 2025

(54) SYSTEM AND METHOD FOR PROVIDING PERSONALIZED CONVERSATION-CONTENT FOR OUTBOUND MARKETING CAMPAIGNS OPERATED VIA A CLOUD-BASED CONTACT CENTER PLATFORM

(71) Applicant: NICE LTD., Ra'anana (IL)

(72) Inventors: Supriya GUIN, Tarakeswar (IN); Shivaji TAMBE, Pune (IN); Sambhaji GAYAKE, Pune (IN); Pankaj CHOUTHMAL, Pune (IN); Manish CHAND, Pune (IN); Imdadul SHARIF, Pune (IN)

(21) Appl. No.: 18/418,277

(22) Filed: Jan. 21, 2024

(51) Int. Cl. G06Q 30/0251; G06N 3/0895; G06Q 30/0242

(52) U.S. Cl. CPC G06Q 30/0271; G06N 3/0895; G06Q 30/0242

(57) ABSTRACT

A computerized-method for providing personalized-content for an interaction of an agent with a customer during an outbound conversational-marketing-campaign of a tenant operated via a cloud-based contact-center-platform. The computerized-method includes: (i) receiving details of the customer and details of the outbound conversational-marketing-campaign of the tenant; (ii) creating a prompt-text based on the received details of the customer and the details of the outbound conversational-marketing-campaign; (iii) generating the personalized content for the interaction with the customer in text-format by executing an LLM AI engine with a trained model with the created prompt-text; (iv) storing a text-file with the generated personalized content in text-format in a contents-database; (v) initiating the interaction of the agent by dialing to the customer; (vi) retrieving the text-file for the interaction from the contents-database; and (vii) sending the text-file to a computerized-device of the agent to be presented via a display-unit that is associated to the computerized-device.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### TECHNICAL FIELD

The present disclosure relates to the field of data analysis and more specifically, to computerized systems and methods for providing personalized content for an interaction of an agent with a customer during an outbound conversational marketing campaign of a tenant that is operated via a cloud-based contact center platform.

### BACKGROUND

In outbound marketing campaigns, generic scripts and non-personalized messaging which are communicated to customers can lead to disengaged customers and low conversion rates. Traditional outbound marketing campaigns often lack predictive analytics that is related to the customer to provide customized content during the interaction. Therefore, in current technical solutions, without customer data analytics, the success of outbound marketing campaigns heavily relies solely on the skills and knowledge of the call agents and insufficient training, or lack of product knowledge can lead to ineffective communication, inability to handle objections, and reduced conversion rates.

Personalization of the outbound marketing campaigns generic scripts often requires real-time decision-making during an interaction. Therefore, there is a need for a technical solution that will provide agents with the necessary tools and systems to make informed real-time decisions. There is a need for a system and method for providing personalized content for an interaction of an agent with a customer during an outbound conversational marketing campaign of a tenant that is operated via a cloud-based contact center platform.

### SUMMARY

There is thus provided, in accordance with some embodiments of the present disclosure, a computerized-method for providing personalized content for an interaction of an agent with a customer during an outbound conversational marketing campaign of a tenant that is operated via a cloud-based contact center platform.

In accordance with some embodiments of the present disclosure, the computerized method includes: (i) receiving details of the customer and details of the outbound conversational marketing campaign of the tenant; (ii) creating a prompt-text based on the received details of the customer and the details of the outbound conversational marketing campaign of the tenant; (iii) generating the personalized content for the interaction with the customer in text-format by executing a Large Language Model (LLM) Artificial intelligence (AI) engine with a trained model that is stored in a models-database with the created prompt-text; (iv) storing a text-file with the generated personalized content for the interaction in text-format for the interaction in a contents-database; (v) initiating the interaction of the agent by dialing to the customer. The dialing to the customer may be performed by operating an Automatic Call Distributor (ACD) software with the details of the customer; (vi) retrieving the text-file for the interaction from the contents-database; and (vii) sending the retrieved text-file to a computerized-device of the agent to present the generated personalized content for the interaction in text-format that is in the text-file, via a display unit that is associated to the computerized-device. The generated personalized content for the interaction in text-format may be used by the agent as a guidance during the interaction with the customer to improve engagement of the customer and effectiveness of the outbound conversational marketing campaign.

Furthermore, in accordance with some embodiments of the present disclosure, the receiving of details of the customer and the details of the outbound conversational marketing campaign of the tenant may be performed by the computerized-method further including: (i) operating a Microservice (MS) for campaign management of the tenant via the cloud-based contact center platform to receive from a user, via a client-device that is associated to a campaign configuration dashboard, data related to the outbound conversational marketing campaign for configuration thereof to be stored in a campaign-database. The data related to the outbound conversational marketing campaign comprising: (a) customers list allocated for the agent; (b) details of each customer in the customers list; and (c) details of the outbound conversational marketing campaign; and (ii) configuring the MS for campaign management to operate the outbound conversational marketing campaign, for each customer in the customers list allocated for the agent.

Furthermore, in accordance with some embodiments of the present disclosure, the details of the outbound conversational marketing campaign may include: (i) campaign name; (ii) campaign ID; (iii) campaign type; (iv) campaign offerings; and (v) campaign description. The details of each customer in the customers list comprising: (i) customer name; (ii) customer contact details; (iii) social media profiles; (iv) hobbies; (v) address; (vi) age; (vii) monthly salary; and (viii) interests.

Furthermore, in accordance with some embodiments of the present disclosure, the creating of the prompt-text may include embedding in a template-prompt one or more details of the customer and one or more campaigns details to yield the prompt-text.

Furthermore, in accordance with some embodiments of the present disclosure, the computerized-method may further include training a model for the LLM AI engine to yield the trained model for the LLM AI engine based on: (i) details of the outbound conversational marketing campaign; and (ii) details of each customer in the customers list. The training may be performed by providing: (i) dispositions and notes from Outbound Detail Records (ODR)s; and (ii) details of customers and details of similar outbound conversational marketing campaign to a trained model from the models-database. The trained model for the LLM AI engine is stored in the models-database with the outbound conversational marketing campaign details.

Furthermore, in accordance with some embodiments of the present disclosure, the computerized-method may further include: (i) continuously train the trained model for the LLM AI engine during the outbound conversational marketing campaign based on data of interactions which were conducted during the outbound conversational marketing campaign; and (ii) storing the trained model for the LLM AI engine, in the models-database.

Furthermore, in accordance with some embodiments of the present disclosure, the data of interactions which were conducted during the outbound conversational marketing campaign may include at least one of: (i) transcriptions of interaction recordings; (ii) dispositions and notes and (iii) transcriptions of interaction recordings along with sentiments which can be used to deduce effectiveness of the interaction.

Furthermore, in accordance with some embodiments of the present disclosure, the computerized-method may further include before the initiating of the interaction with the customer: (i) converting the personalized content in text-format in the text-file to an audio-format; and (ii) storing the converted personalized content in the audio-format as an audio-file in the contents-database.

Furthermore, in accordance with some embodiments of the present disclosure, after the initiating of the interaction with the customer, the computerized-method may further include (i) playing the audio-file to the customer; and (ii) connecting the agent to the interaction when the customer indicates an interest in offerings of the outbound conversational marketing campaign.

There is further provided, in accordance with some embodiments of the present disclosure, a computerized-system for providing personalized content for an interaction of an agent with a customer during an outbound conversational marketing campaign of a tenant that is operated via a cloud-based contact center platform.

In accordance with some embodiments of the present disclosure, the computerized-system may include: one or more processors; an Automatic Call Distributor (ACD) software associated to the cloud-based contact center platform; a computerized-device; a display unit that is associated to the computerized-device; a models-database, and a contents-database; a memory to store the plurality of databases; and a trained model for a Large Language Model (LLM) Artificial intelligence (AI) engine that is stored in a models-database.

Furthermore, in accordance with some embodiments of the present disclosure, the one or more processors may be configured to: (i) receive details of the customer and details of the outbound conversational marketing campaign of the tenant; (ii) create a prompt-text based on the received details of the customer and campaign details; (iii) generate the personalized content for the interaction with the customer in text-format by executing the LLM AI engine with the trained model for the and the created prompt-text; (iv) store a text-file with the generated personalized content for the interaction in text-format in the contents-database; (v) initiate the interaction for the agent by dialing to the customer. The dialing to the customer is performed by operating the ACD software with the details of the customer; (vi) retrieve the text-file for the interaction; and (vii) send the retrieved text-file to a computerized-device of the agent to present the generated personalized content for the interaction in text-format that is in the text-file, via a display unit that is associated to the computerized-device. The generated personalized content for the interaction in text-format is used by the agent as a guidance during the interaction with the customer to improve engagement of the customer and effectiveness of the outbound conversational marketing campaign.

Furthermore, in accordance with some embodiments of the present disclosure, the details of the customer and details of the outbound conversational marketing campaign of the tenant may be received by the computerized-system further including a Microservice (MS) for campaign management of the tenant; a campaign-database stored by the memory, and a campaign configuration dashboard that is connected to the MS for campaign management. The one or more processors may be further configured to: (i) operate the MS for campaign management of the tenant via the cloud-based contact center platform to receive from a user, via a client-device that is associated to the campaign configuration dashboard, data related to the outbound conversational marketing campaign for configuration thereof to be stored in the campaign-database. The data related to the outbound conversational marketing campaign may include (a) customers list allocated for the agent; (b) details of each customer in the customers list; and (c) details of the outbound conversational marketing campaign; and (ii) configure the MS for campaign management to operate the outbound conversational marketing campaign, for each customer in the customers list allocated for the agent.

Furthermore, in accordance with some embodiments of the present disclosure, the details of the outbound conversational marketing campaign may include: (i) campaign name; (ii) campaign ID; (iii) campaign type; (iv) campaign offerings; and (v) campaign description, and the details of each customer in the customers list comprising: (i) customer name; (ii) customer contact details; (iii) social media profiles; (iv) hobbies; (v) address; (vi) age; (vii) monthly salary; and (viii) interests.

Furthermore, in accordance with some embodiments of the present disclosure, the one or more processors may be configured to create the prompt-text by embedding in a template-prompt one or more details of the customer and one or more campaigns details to yield the prompt-text.

Furthermore, in accordance with some embodiments of the present disclosure, the one or more processors may be further configured to train a model for the LLM AI engine to yield the trained model for the LLM AI engine based on: (i) details of the outbound conversational marketing campaign; and (ii) details of each customer in the customers list. The training may be performed by providing: (i) dispositions and notes from Outbound Detail Records (ODR); (ii) details of customers and details of similar outbound conversational marketing campaign to a trained model from the models-database. The trained model for the LLM AI engine is stored in a models-database with the outbound conversational marketing campaign details.

Furthermore, in accordance with some embodiments of the present disclosure, the one or more processors may be configured to: (i) continuously train the trained model for the LLM AI engine during the outbound conversational marketing campaign based on data of interactions which were conducted during the outbound conversational marketing campaign; and (ii) store the trained model for the LLM AI engine in the models-database.

Furthermore, in accordance with some embodiments of the present disclosure, the data of interactions which were conducted during the outbound conversational marketing campaign may include at least one of: (i) transcriptions of interaction recordings; (ii) dispositions and notes; and (iii) transcriptions of interaction recordings along with sentiments which can be used to deduce effectiveness of the interaction.

Furthermore, in accordance with some embodiments of the present disclosure, before the one or more processors initiate the interaction with the customer, the one or more processors may be further configured to: (i) convert the personalized content in text-format in the text-file to an audio-format; and (ii) store the converted personalized content in the audio-format as an audio-file in the contents-database.

Furthermore, in accordance with some embodiments of the present disclosure, after the one or more processors initiate the interaction with the customer, the one or more processors may be further configured to: (i) play the audio-file to the customer; and (ii) connect the agent to the interaction when the customer indicates an interest in offerings of the outbound conversational marketing campaign.

### BRIEF DESCRIPTION OF THE DRAWINGS

In order for the present invention, to be better understood and for its practical applications to be appreciated, the following Figures are provided and referenced hereafter. It should be noted that the Figures are given as examples only and in no way limit the scope of the invention. Like components are denoted by like reference numerals.

FIGS. 1A-IC schematically illustrate a high-level diagram of a computerized-system for providing personalized content for an interaction of an agent with a customer during an outbound conversational marketing campaign of a tenant that is operated via a cloud-based contact center platform, in accordance with some embodiments of the present invention;

FIGS. 2A-2B schematically illustrates a high-level flowchart of a computerized-method for providing personalized content for an interaction of an agent with a customer during an outbound conversational marketing campaign of a tenant that is operated via a cloud-based contact center platform, in accordance with some embodiments of the present invention;

FIG. 3 schematically illustrates a high-level flowchart of a computerized-method for providing personalized content for an interaction of an agent with a customer during an outbound conversational marketing campaign of a tenant that is operated via a cloud-based contact center platform, in accordance with some embodiments of the present invention;

FIGS. 4A-4G schematically illustrate a high-level diagram of a computerized-method for providing personalized content for an interaction of an agent with a customer during an outbound conversational marketing campaign of a tenant that is operated via a cloud-based contact center platform, in accordance with some embodiments of the present invention;

FIG. 5 is an example of a UI for providing a name and uploading a file with outbound conversational marketing campaign details, in accordance with some embodiments of the present invention; and

FIG. 6 is an example of a UI for providing a customers list for the outbound conversational marketing campaign, in accordance with some embodiments of the present invention.

### DETAILED DESCRIPTION

In the following detailed description, numerous specific details are set forth in order to provide a thorough understanding of the disclosure. However, it will be understood by those of ordinary skill in the art that the disclosure may be practiced without these specific details. In other instances, well-known methods, procedures, components, modules, units and/or circuits have not been described in detail so as not to obscure the disclosure.

Although embodiments of the disclosure are not limited in this regard, discussions utilizing terms such as, for example, “processing,” “computing,” “calculating,” “determining,” “establishing”, “analyzing”, “checking”, or the like, may refer to operation(s) and/or process(es) of a computer, a computing platform, a computing system, or other electronic computing device, that manipulates and/or transforms data represented as physical (e.g., electronic) quantities within the computer's registers and/or memories into other data similarly represented as physical quantities within the computer's registers and/or memories or other information non-transitory storage medium (e.g., a memory) that may store instructions to perform operations and/or processes.

Although embodiments of the disclosure are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. Unless explicitly stated, the method embodiments described herein are not constrained to a particular order or sequence. Additionally, some of the described method embodiments or elements thereof can occur or be performed simultaneously, at the same point in time, or concurrently. Unless otherwise indicated, use of the conjunction “or” as used herein is to be understood as inclusive (any or all of the stated options).

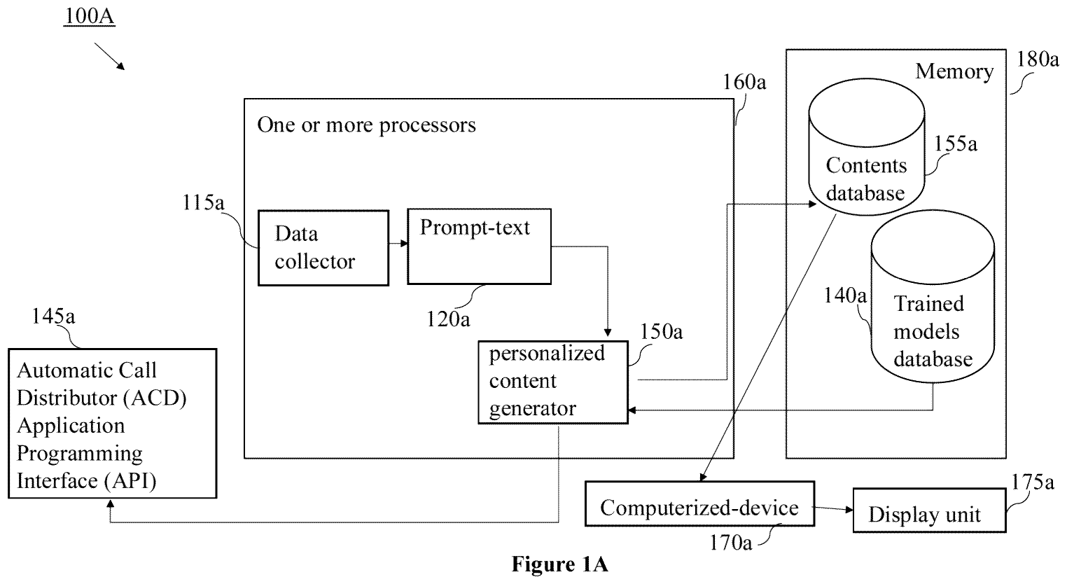

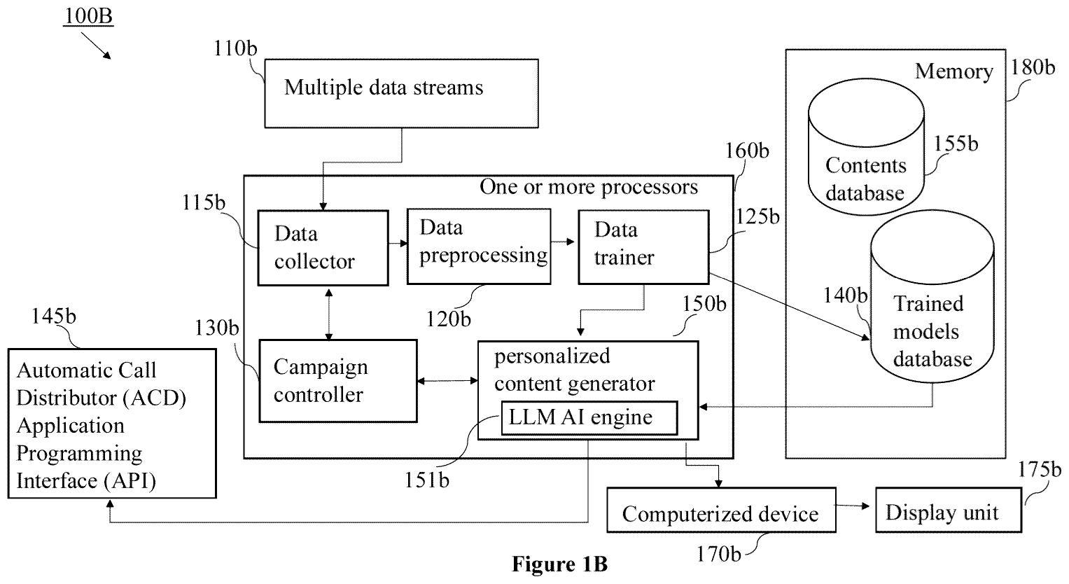

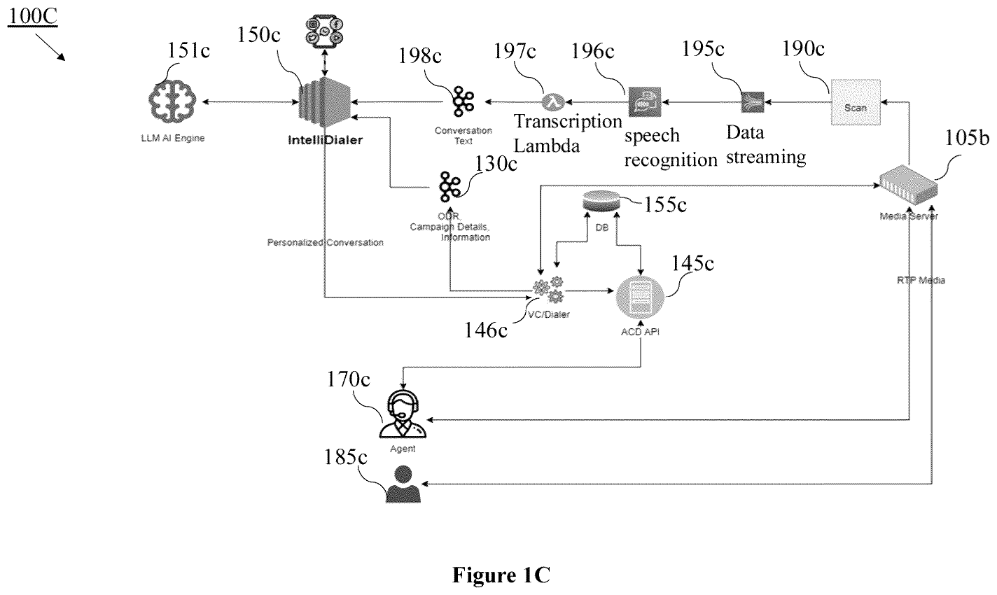

FIG. 1A schematically illustrates a high-level diagram of a computerized-system 100A for providing personalized content for an interaction of an agent with a customer during an outbound conversational marketing campaign of a tenant that is operated via a cloud-based contact center platform, in accordance with some embodiments of the present invention.

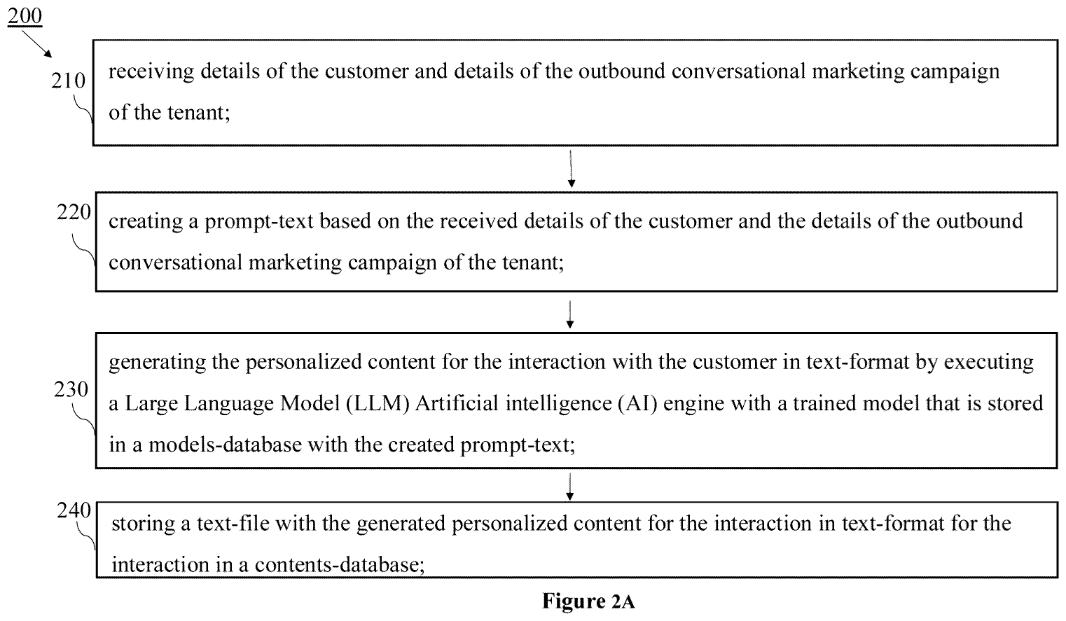

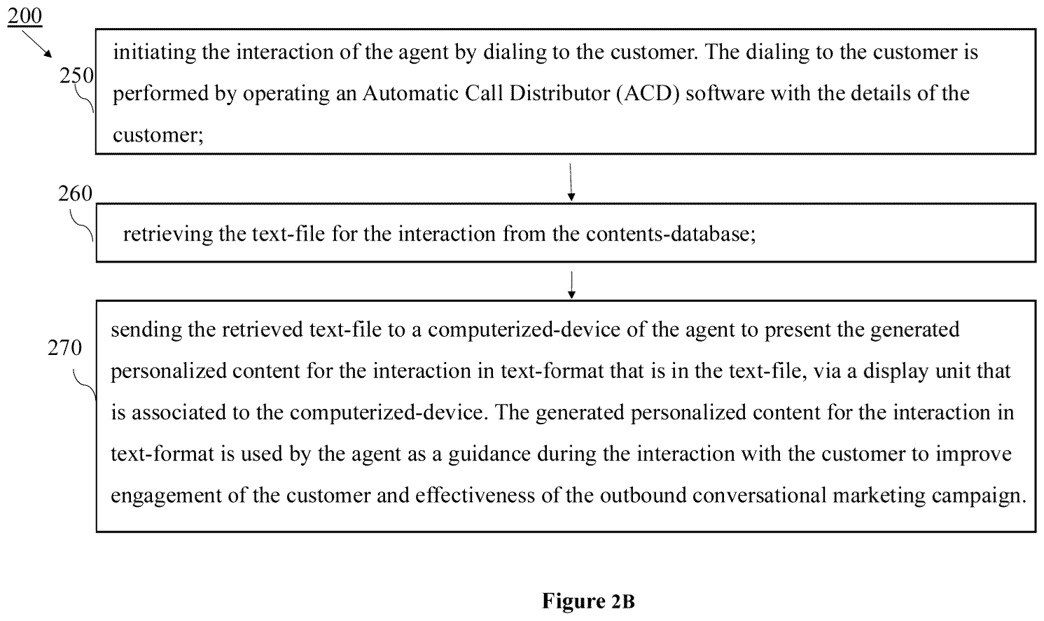

According to some embodiments of the present disclosure, a system, such as computerized-system 100A, may implement a computerized-method for providing personalized content for an interaction of an agent with a customer during an outbound conversational marketing campaign of a tenant that is operated via a cloud-based contact center platform, such as computerized-method 200 in FIGS. 2A-2B.

According to some embodiments of the present disclosure, computerized-system 100A may include one or more processors 160a, an Automatic Call Distributor (ACD) Application Programming Interface (API) 145a that is associated to the cloud-based contact center platform to initiate calls to customers, a computerized-device 170a for the agent and a display unit 175a that may be associated to the computerized-device to present the personalized content for an interaction of an agent with a customer during an outbound conversational marketing campaign of a tenant that is operated via a cloud-based contact center platform.

According to some embodiments of the present disclosure, computerized-system 100A may further include a models-database, such as trained models database 140a to store trained models for the Large Language Model (LLM) Artificial intelligence (AI) engine, and a contents-database 155a to store each text-file that includes the personalized content for the interaction of the agent with the customer. The plurality of databases may be stored in memory 180a.

According to some embodiments of the present disclosure, computerized-system 100A may operate the one or more processors 160a to receive details of the customer and details of the outbound conversational marketing campaign of a tenant, for example, by operating a data collector 115a module.

According to some embodiments of the present disclosure, the data that has been collected by the data collector 115a module may be used to create a prompt-text 120a. The prompt-text may be created by embedding in a template-prompt one or more details of the customer and one or more campaign details to yield the prompt-text 120a.

According to some embodiments of the present disclosure, the creation of the prompt-text 120a may be based on the details obtained from the customer and the outbound conversational marketing campaign. These details may be embedded or inserted into corresponding placeholders in the template-prompt.

According to some embodiments of the present disclosure, each tenant may have a template-prompt that is tailored to the tenant profile and to the outbound conversational marketing campaign goals. For example, a template-prompt may be as follows:

“Create a personalized sales pitch for [Customer Name], a [Age]-year-old [Likes] with phone [Phone Number] and a [Monthly Salary] monthly salary. Consider customer positive past call disposition about [Card Type]. Recommend [Number of cards] suitable credit cards tailored to customer interests and finances”. After the embedding the prompt-text may be for example, “Create a personalized sales pitch for John Doe, a 30-year-old food enthusiast with phone 555-123-4567 and a $10,000 monthly salary. Consider his positive past call disposition about Millennia card. Recommend two suitable credit cards tailored to his interests and finances”.

According to some embodiments of the present disclosure, the personalized content for the interaction with the customer in text-format may be generated by operating a personalized content generator 150a which may be implemented as a Large Language Model (LLM) Artificial intelligence (AI) engine. The LLM AI engine may execute a trained model with the created prompt-text 120a.

According to some embodiments of the present disclosure, the text-file may be stored with the generated personalized content for the interaction in text-format, in a database, such as contents-database 155a.

According to some embodiments of the present disclosure, the interaction for the agent may be initiated by dialing to the customer by operating the ACD API 145a with the details of the customer. Then, the text-file for the interaction may be retrieved from the contents-database 155a and may be sent to a computerized-device 170a of the agent to present the generated personalized content for the interaction in text-format, via a display unit 175a that may be associated to the computerized-device 170a.

According to some embodiments of the present disclosure, optionally, the interaction for the agent under the outbound conversational marketing campaign of the tenant may be initiated via digital channels, such as WhatsApp®, and may be carried out via chat messages.

According to some embodiments of the present disclosure, the generated personalized content for the interaction in text-format may be used by the agent as a guidance during the interaction with the customer to improve engagement of the customer and effectiveness of the outbound conversational marketing campaign.

According to some embodiments of the present disclosure, the data that has been collected by the data collector 115a module may include customers list allocated for the agent, details of each customer in the customers list and details of the outbound conversational marketing campaign.

According to some embodiments of the present disclosure, the details of the outbound conversational marketing campaign may include (i) campaign name; (ii) campaign ID; (iii) campaign type; (iv) campaign offerings; and (v) campaign description. The details of each customer in the customers list may include (i) customer name; (ii) customer contact details; (iii) social media profiles; (iv) hobbies; (v) address; (vi) age; (vii) monthly salary; and (viii) interests.

According to some embodiments of the present disclosure, before the initiating of the interaction with the customer by the ACD API 145a, the personalized content in text-format in the text-file may be converted to an audio-format and stored as an audio-file in the contents-database 155a. Then, after the initiating of the interaction with the customer, the audio-file may be played to the customer and the agent may be connected to the interaction by the ACD API 145a via the agent's computerized-device 170a, when the customer indicates an interest in offerings of the outbound conversational marketing campaign.

FIG. 1B schematically illustrates a high-level diagram of a computerized-system 100B for providing personalized content for an interaction of an agent with a customer during an outbound conversational marketing campaign of a tenant that is operated via a cloud-based contact center platform, in accordance with some embodiments of the present invention.

According to some embodiments of the present disclosure, system 100B may include the same components as system 100A and may implement a computerized-method, such as computerized-method 200 in FIGS. 2A-2B for providing personalized content for an interaction of an agent with a customer during an outbound conversational marketing campaign of a tenant that is operated via a cloud-based contact center platform.

According to some embodiments of the present disclosure, system 100B may provide personalized content for an interaction of an agent with a customer during an outbound conversational marketing campaign of a tenant that is operated via a cloud-based contact center platform.

According to some embodiments of the present disclosure, one or more processors 160b may be configured to operate a campaign controller 130b to run the outbound conversational marketing campaign of the tenant, via the cloud-based contact center platform, based on data received from multiple data streams 110b. The campaign controller 130b may operate data collector 115b to receive the data from the multiple data streams 110b. The data from the multiple data streams may be prepared and processed by a data preprocessing module 120b, such that it may be adequately fed into the data trainer 125b.

According to some embodiments of the present disclosure, the data preprocessing module 120b may include feature extraction by extracting relevant features from each data source, such as sentiment scores from social media posts, keywords from call dispositions, and relevant campaign information. The data preprocessing module 120b may further include data integration by combining the extracted features from the pre-processed data into a unified representation for input into the Large Language Model (LLM) Artificial intelligence (AI) engine 151b, which may be executed by the personalized content generator 150b.

According to some embodiments of the present disclosure, the multiple data streams 110b may include agent-customer interactions, details of the outbound conversational marketing campaign, customer's details, such as, name, age, gender, hobbies, interests, location, social profile and the like and Outbound Detail Records (ODR) which includes call dispositions set by agent for example, interested, not interested, request callback and the like.

According to some embodiments of the present disclosure, details of the outbound conversational marketing campaign may be for example, five credit card types which are considered for a credit card campaign. Each credit card may have benefits for the customers. First credit card may be best suitable for customers who are frequent travelers. It's key features are a. 5% cashback on online flight tickets booking, clothing and transport services like cab-aggregator and taxi-aggregator. B. air lounge access: eight complimentary domestic lounge access per calendar year, best suitable for domestic and international travelers; and c. fuel surcharge waiver, best for travelling. The eligibility criteria may be for salaried and self-employed: age criteria in the range of 21-40 and income criteria gross monthly income greater than 65K. Second credit card may be best suitable for foodies customers. It's key features are a. up to 20% discount on dining b. lounge access: 2 complimentary domestic lounge access per calendar year c. fuel surcharge waiver d. contactless card for convenient and secure payments at retail outlets. The eligibility criteria may be for salaried and self-employed: age criteria in the range of 18-55 and income criteria gross monthly income greater than 35K. Third credit card may be best suitable for customers who are frequent online shoppers. It's key features are a. 10% cashback on online shopping, clothing and transport services like cab-aggregator and taxi-aggregator, best for online shoppers b. Up to 2% discount on dining c. lounge access: 2 complimentary domestic lounge Access per calendar year d. contactless card for convenient and secure payments at retail outlets. The eligibility criteria may be for salaried and self-employed: age criteria in the range of 30-55 and income criteria gross monthly income greater than 100K. Fourth credit card may be best suitable for customers who are frequent movies and plays watchers. It's key features are a. 20% cashback on movie tickets booking and transport services like cab-aggregator and taxi-aggregator. B. up to 5% discount on dining and food at movie theaters. C. contactless card for convenient and secure payments at retail outlets. The eligibility criteria may be for salaried and self-employed: age criteria in the range of 25-50 and income criteria gross monthly income greater than 150K. The fifth credit card may be best suitable for customers who are frequent gym and golf club players. It's key features are a. 1-year complimentary gym pro membership b. 1-year complimentary golf membership access c. contactless card for convenient and secure payments at retail outlets. The eligibility criteria may be for salaried and self-employed: age criteria in the range of 35-50 and income criteria gross monthly income greater than 400K.

According to some embodiments of the present disclosure, before each interaction is initiated with the customer, via the Automatic Call Distributor (ACD) Application Programming Interface (API) 145b under the conversational marketing campaign of the tenant, a personalized content for the interaction of the agent with the customer may be provided by the personalized content generator 150b, based on details of the customer and details of the outbound conversational marketing campaign of the tenant.

According to some embodiments of the present disclosure, the multiple data streams 110b may include for example, transcriptions of interaction recordings which are related to customers in the list of customers for the outbound conversational marketing campaign. Other parameters that may indicate that the transcriptions of interaction recordings should be included in the multiple data streams 110b are campaign type, product of the campaign, product company, promotional phrases, and the like. The multiple data streams may further include dispositions and notes and transcriptions of interaction recordings along with sentiments which can be used to deduce effectiveness of the interaction, and the details of the customer and details of the outbound conversational marketing campaign.

According to some embodiments of the present disclosure, the data related to the outbound conversational marketing campaign may include: (a) customers list allocated for the agent; (b) details of each customer in the customers list; and (c) details of the outbound conversational marketing campaign.

According to some embodiments of the present disclosure, for example, the details of the customer and details of the outbound conversational marketing campaign may be received by the one or more processors 160b further configured to operate a Microservice (MS) for campaign management of the tenant via the cloud-based contact center platform, such as campaign controller 130b, to receive from a user, data related to the outbound conversational marketing campaign for configuration thereof via a client-device that is associated to a campaign configuration dashboard (not shown). The data may be stored in a campaign-database (not shown).

According to some embodiments of the present disclosure, the MS for campaign management, such as campaign controller 130b, may be configured to operate the outbound conversational marketing campaign, for each customer in the customers list allocated for the agent.

According to some embodiments of the present disclosure, the details of the outbound conversational marketing campaign may include (i) campaign name; (ii) campaign ID; (iii) campaign type; (iv) campaign offerings; and (v) campaign description. The details of each customer in the customers list may include (i) customer name; (ii) customer contact details; (iii) social media profiles; (iv) hobbies; (v) address; (vi) age; (vii) monthly salary; and (viii) interests.

According to some embodiments of the present disclosure, the model that may be executed by the LLM AI engine 151b, may be trained by a data trainer module 125b. The data trainer 125b may receive the data for the training from the data preprocessing module 120b. Before the training of the model for the LLM AI engine 151b, the received data may be prepared by gathering and organizing the data, structuring, and formatting the data and tokenizing and encoding the data.

According to some embodiments of the present disclosure, the gathering and organizing the data, structuring, and formatting the data and tokenizing and encoding the data may include accumulating relevant text data from various sources such as customer phone number, customer emails, product reviews, campaign information, call dispositions and the like and then the data may be arranged in a structured format, such as Comma-Separated Values (CSV) files or databases for efficient processing.

According to some embodiments of the present disclosure, address inconsistencies, errors such as, typos, and missing values may be corrected to enhance quality. Then, the text may be split into meaningful units e.g., words, phrases, or sub-words, for model comprehension. Numerical representations may be assigned to tokens for mathematical processing by the model: for example: “Hello, how can I help you?” might be tokenized as [“Hello”, “,”, “how”, “can”, “I”, “help”, “you” “?”] and encoded as [15, 23, 47, 6, 92, 5, 9, 12].

According to some embodiments of the present disclosure, a model, may be selected as the model that may be executed by the LLM AI engine 151b. For example, the selected model may be Generative Pre-trained Transformer 3 (GPT-3) and the LLM AI engine 151b may be Open AI.

According to some embodiments of the present disclosure, during training of the model by the data trainer module 125b, the model may be fine-tuned by configuring training parameters, implementing a fine-tuning process, and evaluating the model performance. The evaluation of the model performance involves executing campaigns with test customers. Then, the assessment may be conducted by analyzing the final call disposition, sentiment score, and customer conversion rate.

According to some embodiments of the present disclosure, after the training of the model by the data trainer module 125b, the selected model may be stored in a database, such as trained models database 140b. The stored model may be deployed and monitored for its performance in system 100B.

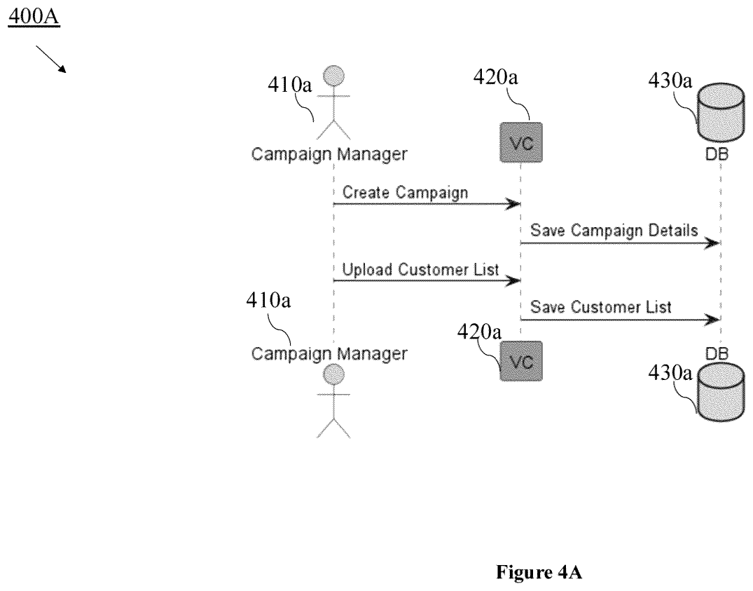

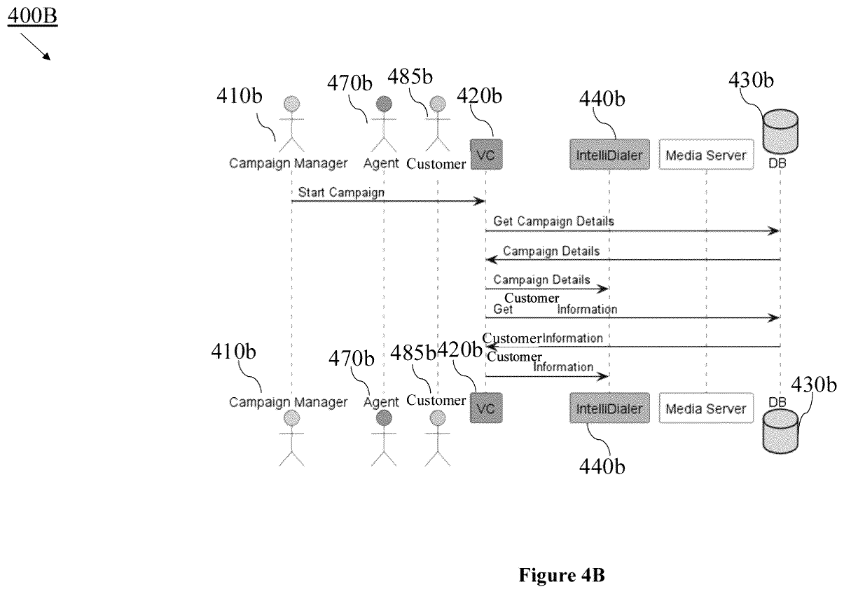

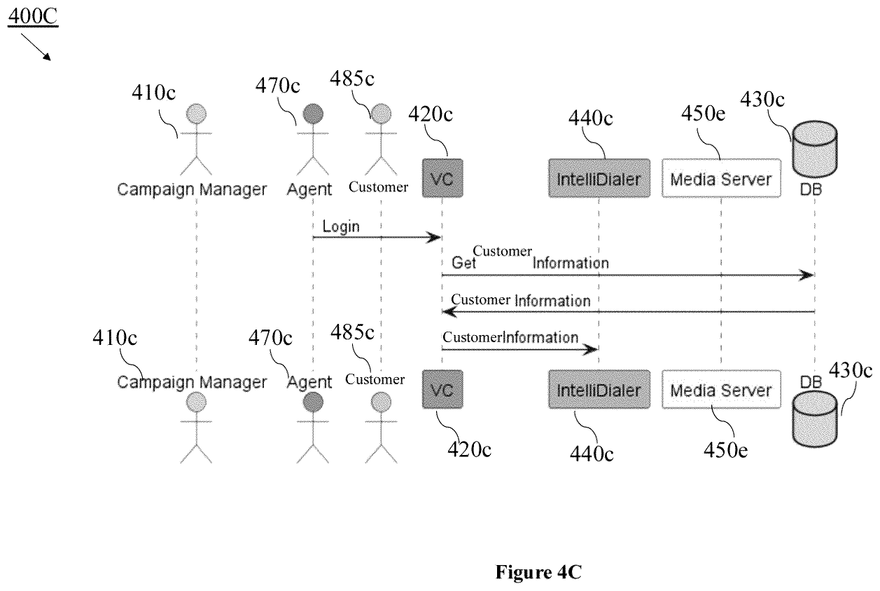

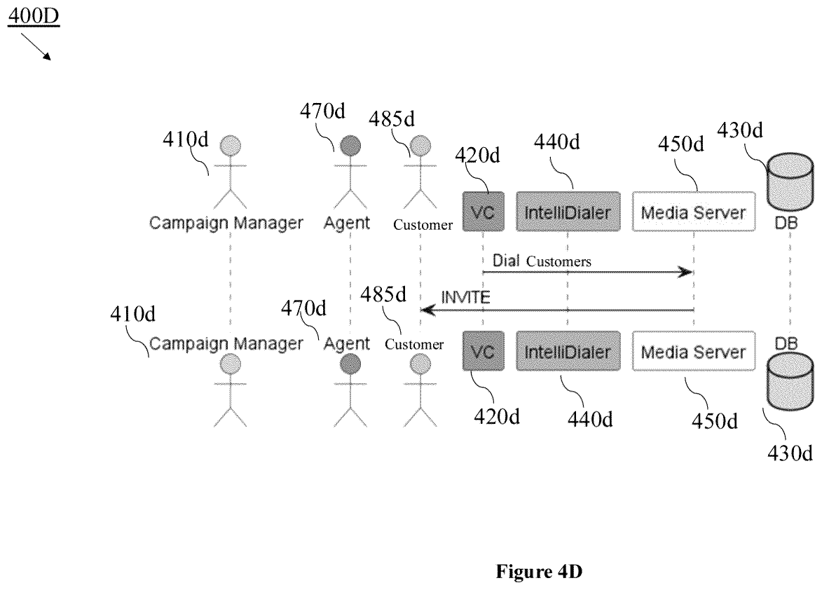

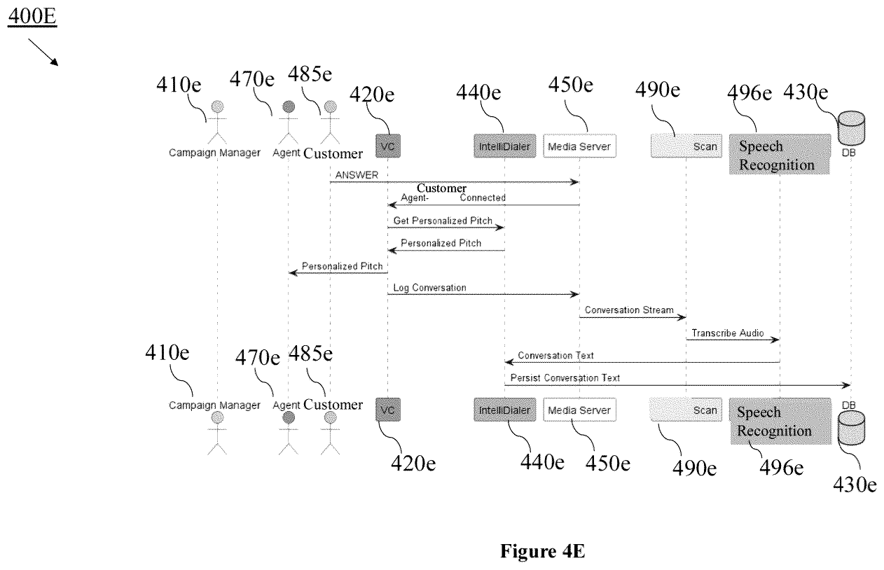

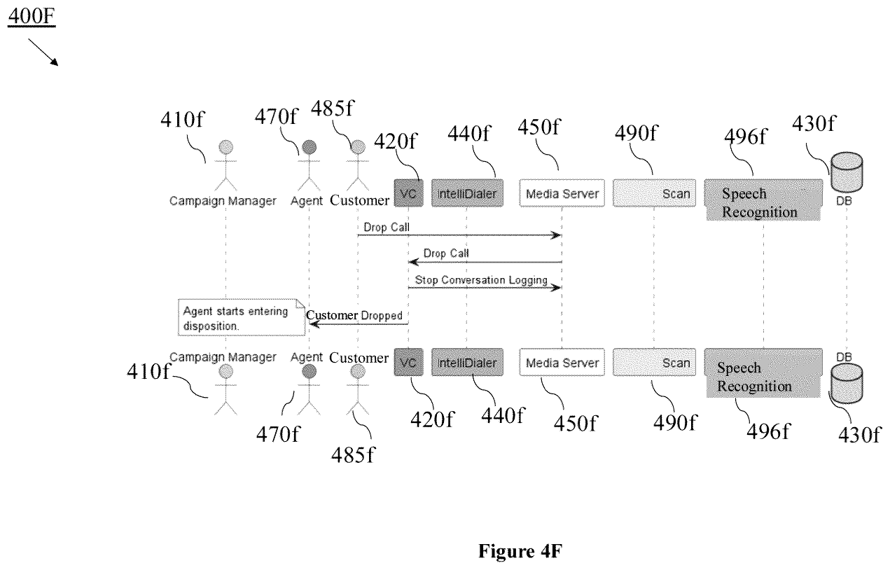

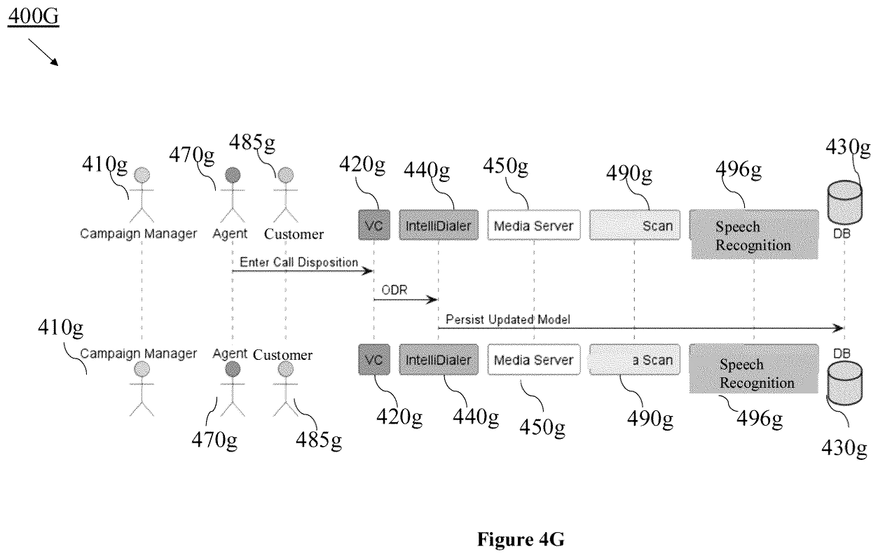

According to some embodiments of the present disclosure, the personalized content generator 150b may fine-tune the trained model by continuously collecting feedback from successful and unsuccessful personalized content. Indications for successful personalized content may be based on related call disposition, sentiment score of interaction, and customer conversion rate, to fine-tune the model, for example, as shown in FIG. 4G and improving its accuracy and personalization over time.

According to some embodiments of the present disclosure, when the campaign controller 130b, such as the MS for campaign management, may operate the outbound conversational marketing campaign for the tenant, it may operate the personalized content generator 150b, which may use the trained model from the trained models database 140b and use the data that has been received by the data collector 115b module from multiple data streams 110b, to provide personalized content for an interaction of an agent with a customer during the outbound conversational marketing campaign.

According to some embodiments of the present disclosure, the trained model for the LLM AI engine 151b may be continuously trained during the progress of the outbound conversational marketing campaign based on data, such as sentiment score of the interaction, call disposition of the interaction and customer conversion rate from interactions which were conducted, during the outbound conversational marketing campaign, as shown in FIG. 4G and then the trained model for the LLM AI engine 151b may be stored in the models-database, such as trained models database 140b and used by the personalized content generator 150b for the next interactions of the outbound conversational marketing campaign.

FIG. 1C schematically illustrates a high-level diagram of a computerized-system 100C for providing personalized content for an interaction of an agent with a customer during an outbound conversational marketing campaign of a tenant that is operated via a cloud-based contact center platform, in accordance with some embodiments of the present invention.

According to some embodiments of the present disclosure, system 100C may include the same components as system 100B and may implement a computerized-method, such as computerized-method 200 in FIGS. 2A-2B for providing personalized content for an interaction of an agent with a customer during an outbound conversational marketing campaign of a tenant that is operated via a cloud-based contact center platform.

According to some embodiments of the present disclosure, IntelliDialer 150c may be a personalized content generator, such as personalized content generator 150b in FIG. 1B. The IntelliDialer 150c may execute an LLM AI engine 151c, which may operate a trained model, to provide a personalized content for an interaction of an agent with a customer during an outbound conversational marketing campaign of a tenant that is operated via a cloud-based contact center platform.

According to some embodiments of the present disclosure, the Virtual Cluster (VC) dialer 146c manages both inbound and outbound contact center calls and various contact center features and may be associated to an ACD API 145c, such as ACD API 145b in FIG. 1B. For outbound calls, the VC dialer 146c may interact with IntelliDialer 150c via various Kafka Topics. The Kafka Topics are used for sending Outbound Details Record (ODR), customer information, campaign information, requesting personalized content and getting the response. The VC dialer 146c may forward information, such as call dispositions, campaign details 130c, and customer information to IntelliDialer 150c.

According to some embodiments of the present disclosure, a contact-handling web application enables agents in the contact center to interact with contacts using phone calls, voicemail, email, chat, work items. When IntelliDialer 150c provides personalized content, the VC dialer 146c may send it to the contact-handling web application UI, via the ACD API 145c, so that the contact-handling web application UI can display it to the agent 170c via a display unit, such as display unit 175b in FIG. 1B, when it is connected to the customer along with call information.

According to some embodiments of the present disclosure, the DB 155c is a database that stores the VC dialer configuration data along with various state related information about the agent 170c, campaigns 130c, skills, customer information, calls state and the like.

According to some embodiments of the present disclosure, when the ACD API 145c receives personalized content for an interaction with a customer 185c, it may send it to the contact-handling web application UI for the agent 170c, e.g., via Hypertext Transfer Protocol (HTTP) long polling technique.

According to some embodiments of the present disclosure, the media server 105b may be a media processing box which handles all incoming and outgoing Real-time Transport Protocol (RTP) traffic and RTP mixing. The media server 105b may connect RTP streams from the agent and RTP streams from the customer. The media server 105b may write agent and customer conversation RTP stream, for example, to a Kafka Topics. The IntelliDialer 150c may read from the Kafka topics to continue the fine-tuning of the trained model.

According to some embodiments of the present disclosure, a scan service, such as scan 190c may be a single ingest pipeline that sorts, searches, analyzes, and cross-references data from a host of text and audio inputs. Scan 190c may listen to recordings of interactions in real time and may feed it to a serverless data streaming service, such as Amazon® Kinesis stream to provide customer interaction analytics based on insights from audio, chat, e-mail, social and text interactions.

According to some embodiments of the present disclosure, a speech recognition service 196c, such as Amazon® Transcribe may read from the data streaming 195c, e.g., audio Kinesis stream for real time conversation data to convert audio data to raw textual data. This speech recognition service 196c performs Natural language processing (NLP) processing along with sentiment analysis.

According to some embodiments of the present disclosure, when the interaction under the outbound conversational marketing campaign is conducted via chat, e-mail, social-media, then the speech to text may not be required and only the sentiment analysis may be performed.

According to some embodiments of the present disclosure, transcription lambda 197c may receive raw conversation text from an automatic speech recognition service, such as Amazon® Transcribe, and may transform and write to a Kafka Topic, e.g., conversation text 198c, which IntelliDialer 150c may be subscribed to.

According to some embodiments of the present disclosure, the IntelliDialer 150c may be implemented as an MS that may continuously process data from various sources, such as Kafka Topics, social media and the like and may keep training the model for the LLM AI engine 151c, to be used for generating personalized content for an interaction with a customer under the outbound conversational marketing campaign. The same model may be used for future marketing campaigns which keeps on getting fine-tuned during the progress of the marketing campaign.

According to some embodiments of the present disclosure, Kafka Topics may be for example, the following sample list of Kafka Topics:
1. Call Disposition/Outbound Detail Record (ODR): Once call is dispositioned, VC dialer writes disposition details to this topic.
2. Campaign Details: When Campaign starts, VC dialer writes campaign details to this topic.
3. Customer Information: To get personalized content, VC dialer writes customer information such as name, contact number, social media IDs etc. to this topic.
4. Conversations: Transcribed agent-customer conversations.
5. Data From Previous Campaigns: it may be useful when the campaign starts as a starting point for the new campaign.

According to some embodiments of the present disclosure, when the IntelliDialer 150c may receive a request to generate personalized content, it may request LLM AI engine 151c, such as Open AI, to execute the trained model to generate the personalized content.

FIGS. 2A-2B schematically illustrates a high-level diagram of a computerized-method 200 for providing personalized content for an interaction of an agent with a customer during an outbound conversational marketing campaign of a tenant that is operated via a cloud-based contact center platform, in accordance with some embodiments of the present invention;

According to some embodiments of the present disclosure, operation 210 comprising receiving details of the customer and details of the outbound conversational marketing campaign of the tenant.

According to some embodiments of the present disclosure, operation 220 comprising creating a prompt-text based on the received details of the customer and the details of the outbound conversational marketing campaign of the tenant.

According to some embodiments of the present disclosure, operation 230 comprising generating the personalized content for the interaction with the customer in text-format by executing a Large Language Model (LLM) Artificial intelligence (AI) engine with a trained model that is stored in a models-database with the created prompt-text.

According to some embodiments of the present disclosure, operation 240 comprising storing a text-file with the generated personalized content for the interaction in text-format in a contents-database.

According to some embodiments of the present disclosure, operation 250 comprising initiating the interaction of the agent by dialing to the customer. The dialing to the customer is performed by operating an Automatic Call Distributor (ACD) software with the details of the customer.

According to some embodiments of the present disclosure, operation 260 comprising retrieving the text-file for the interaction from the contents-database.

According to some embodiments of the present disclosure, operation 270 sending the retrieved text-file to a computerized-device of the agent to present the generated personalized content for the interaction in text-format that is in the text-file, via a display unit that is associated to the computerized-device. The generated personalized content for the interaction in text-format is used by the agent as a guidance during the interaction with the customer to improve engagement of the customer and effectiveness of the outbound conversational marketing campaign.

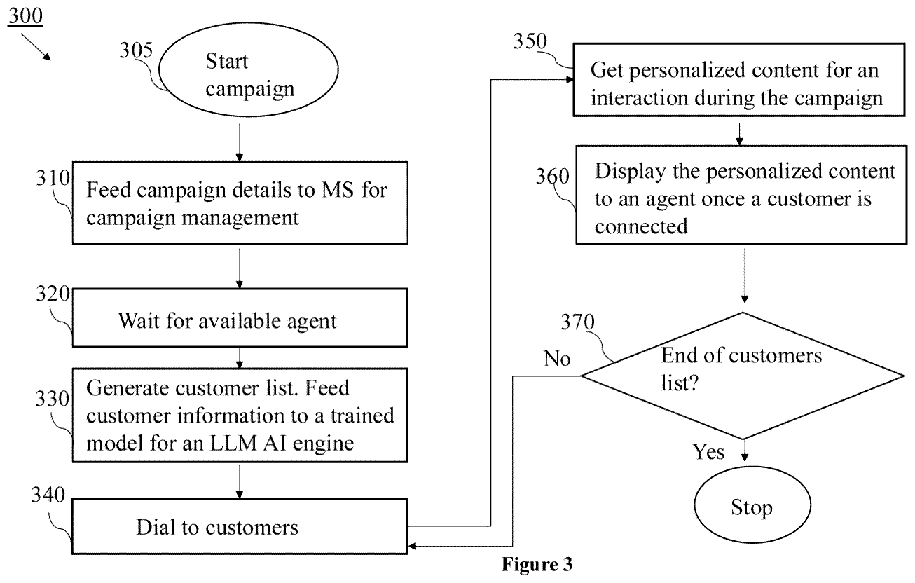

FIG. 3 schematically illustrates a high-level flowchart of a computerized-method 300 for providing personalized content for an interaction of an agent with a customer during an outbound conversational marketing campaign of a tenant that is operated via a cloud-based contact center platform, in accordance with some embodiments of the present invention.

According to some embodiments of the present disclosure, when the campaign starts 305, the campaign details may be fed into MS for campaign management 310. The MS for campaign management, may be for example, such as campaign controller 130b in FIG. 1B.

According to some embodiments of the present disclosure, waiting for available agent 320 and then generating a customer list to feed customer information to a trained model executed by the LLM AI engine 330.

According to some embodiments of the present disclosure, based on the customer information, dialing to customers 340 and then, getting personalized content for an interaction during the campaign 350.

According to some embodiments of the present disclosure, the personalized content may be displayed to an agent once a customer is connected 360.

According to some embodiments of the present disclosure, checking if it is the end of customers list 370. If it is then the campaign stops otherwise calling the next customer.

According to some embodiments of the present disclosure, if there are more customers to engage, the next customer in the list of customers is called, and the transcription of the interaction with previous customer may be used to fine-tune the model, thus, perpetuating an iterative process of continuous improvement of the model that is executed by the LLM AI engine, such as LLM AI engine 151c in FIG. 1C. Each loop refines the model's understanding of customer behavior, ensuring a progressive enhancement of campaign effectiveness. Once all the numbers of the customers in the list of customers are dialed and there are no more customers left then the outbound conversational marketing campaign gets ended.

FIG. 4A schematically illustrates a high-level diagram 400A of creating a campaign for the computerized-method for providing personalized content for an interaction of an agent with a customer during an outbound conversational marketing campaign of a tenant that is operated via a cloud-based contact center platform, in accordance with some embodiments of the present invention.

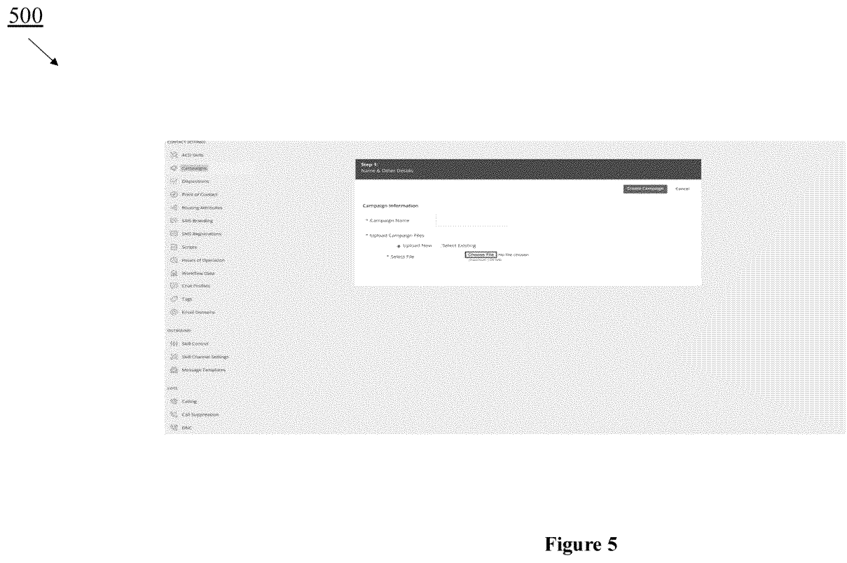

According to some embodiments of the present disclosure, the outbound conversational marketing campaign may be created by a user, such as campaign manager 410a that may interact via a Hypertext Transfer Protocol Secure (HTTPS) interface with the VC dialer 420a, such as such as VC dialer 146c in FIG. 1C. When creating the campaign, the campaign manager enters details about the campaign. The details of the campaign may be entered for example, by uploading Comma-Separated Values (CSV), XLS or XLSX file. The VC 420a, such as VC dialer 146c in FIG. 1C, may store this information into a database 430a, such as DB 155c in FIG. 1C. A name has to be provided to the campaign and the file has to be uploaded for example, via UI 500, in FIG. 5.

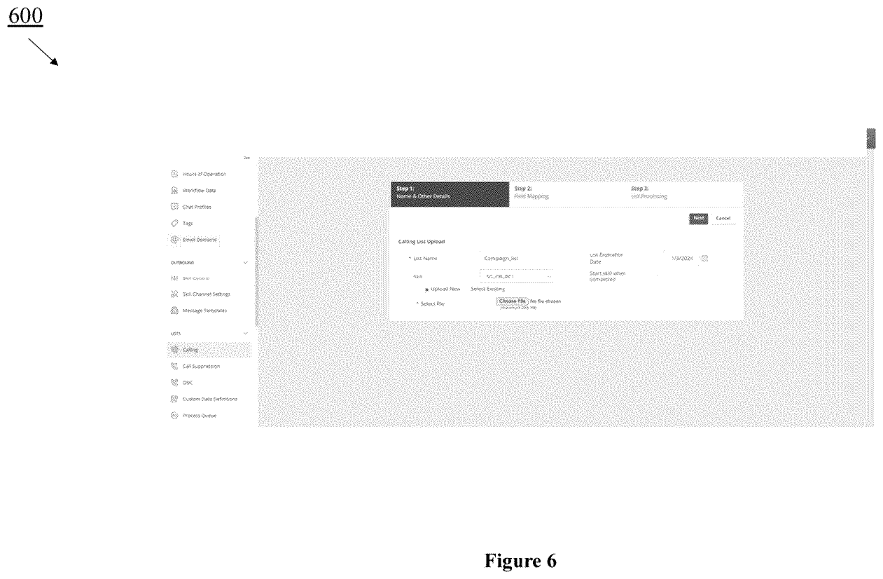

According to some embodiments of the present disclosure, the customers list may be uploaded, for example, via UI 600 in FIG. 6. The customers list may be a CSV, XLS or XLSX file details about the customers for the campaign. Alternatively, the campaign manager 410a can configure to get this customers list from servers of the tenant after the campaign starts. The file may contain details such as name, phone, number, age, gender, hobbies, interests, address, social media IDs. For example, John Doe, 111-222-333, 35, male, shopping, reading, Italian food, Fictional books, USA, and john.doe@social-m.

According to some embodiments of the present disclosure, as shown in FIG. 5, the campaign manager 410a may upload an excel sheet by clicking the “Choose File” button. The campaign manager 410a then maps fields and then a customers list may be saved into the database 430a, such as DB 155c in FIG. 1C. Alternatively, the tenant may expose APIs, e.g., Representational State Transfer (REST) API, via which the VC 420a may request a list of customers to dial for the campaign. The campaign manager 410a may start the outbound campaign.

According to some embodiments of the present disclosure, the files may be uploaded using File transfer protocol (FTP) protocol through a fileserver. The databases may be implemented by Structured Query Language (SQL) database.

FIG. 4B schematically illustrates a high-level diagram 400B of a campaign start for computerized-method for providing personalized content for an interaction of an agent 470b with a customer during an outbound conversational marketing campaign of a tenant that is operated via a cloud-based contact center platform, in accordance with some embodiments of the present invention.

According to some embodiments of the present disclosure, once the VC 420b, such as such as VC dialer 146c in FIG. 1C, notice that the campaign started, the VC 420b may initialize campaign parameters, such as dialing ratio, abandon rate and the like. Then, the VC 420b may establish a connection with IntelliDialer 440b, such as IntelliDialer 150c in FIG. 1C, if not connected already and sets up campaign tracking metrics by the initialized campaign parameters.

According to some embodiments of the present disclosure, the VC 420b may get the campaign details from the database, such as DB 430b, and such as DB 155c in FIG. 1C. The campaign details are the details that a campaign manager 410b has uploaded when the campaign has been created, as shown in FIG. 4A. Once the DB 430b returns the campaign details, the VC 420b may send them to IntelliDialer 440b. This is an indication to IntelliDialer 440b that the dialer campaign is about to start, and then it sets up internal data structures to prepare for it. For example, the following details may be sent to IntelliDialer 440b, campaign name and ID, campaign type and campaign description.

According to some embodiments of the present disclosure, the VC 420b may get a list of customers to dial. The VC 420b may tell how many customers are needed based on the campaign parameters, such as dialing ratio, abandon rate etc. Once the DB 430b returns the list of customers, the VC 420b may save it in memory and forward it to IntelliDialer 440b.

According to some embodiments of the present disclosure, the list of customers may include the information about the customers, for example, customer name, customer phone number, social media profiles, hobbies, address, and interests. The IntelliDialer 440b may use this data along with past dispositions and notes from Outbound Detail Records (ODR), social media profile data and past call recordings to generate the personalized content and send it to the VC 420b.

According to some embodiments of the present disclosure, the VC 420b and the IntelliDialer 440b may communicate via Kafka Topics.

For example, a message from the VC to the IntelliDialer may be as follows:
{
   “Type”: “Start Campaign”,
   “Campaign Name”: “ABC Credit Card”,
   “Campaign ID”: “aaa-111”,
   “Campaign Description”: “Types of credit cards: Silver, Gold and Platinum . . . ”,
   “Customer Information”:
      [
         {
         “Name”: “John Deo L”,
         “Phone Number”: “111-222-3333”,
         “Age”: 35,
         “Customer ID”: “aaa”
         “Gender”: “Male”,
         “Hobbies”: “Shopping, Reading”,
         “Interests”: “Italian Food, Fictional Books”,
         “Address”: “USA”,
         “Social Media IDs”: “john.deo.l@social-media”
         },
         . . . .
      ]
}

According to some embodiments of the present disclosure, the DB 430b and the VC 420b may communicate, for example, via a standard DB interface and SQL Remoting messages.

FIG. 4C schematically illustrates a high-level diagram 400C of a computerized-method for providing personalized content for an interaction of an agent with a customer during an outbound conversational marketing campaign of a tenant that is operated via a cloud-based contact center platform, in accordance with some embodiments of the present invention.

According to some embodiments of the present disclosure, once the agent logs into the system, and the outbound conversational marketing campaign of a tenant is running, if the VC 420c, such as such as VC dialer 146c in FIG. 1C, doesn't have customers to dial to, it requests contacts from the DB 430c. Once the DB 430c provides a list of contacts, the VC 420c also sends them to IntelliDialer 440c, such as IntelliDialer 150c in FIG. 1C. The IntelliDialer 440c, such as IntelliDialer 150c in FIG. 1C, and such as personalized content generator 150a in FIG. 1A and personalized content generator 150b in FIG. 1B, may prepare personalized content for each customer in the list of customers.

According to some embodiments of the present disclosure, optionally, when the agent finishes a call and becomes available for new calls, the IntelliDialer 440c may prepare personalized content for the customer of the new call.

According to some embodiments of the present disclosure, a message from the VC
{
   “Type”: “New Customers”,
   “Campaign Name”: “ABC Credit Card”,
   “Campaign ID”: “aaa-111”,
   “Customer Information”:
   [
      {
         “Name”: “John Deo L”,
         “Phone Number”: “111-222-3333”,
         “Age”: 35,
         “Customer ID”: “aaa”,
         “Gender”: “Male”,
         “Hobbies”: “Shopping, Reading”,
         “Interests”: “Italian Food, Fictional Books”,
         “Address”: “USA”,
         “Social Media IDs”: john.deo.l@social-media,
      },
      . . . .
   ]
}

FIG. 4D schematically illustrates a high-level diagram 400D of a computerized-method for providing personalized content for an interaction of an agent with a customer during an outbound conversational marketing campaign of a tenant that is operated via a cloud-based contact center platform, in accordance with some embodiments of the present invention.

According to some embodiments of the present disclosure, the VC 420d, such as VC dialer 146c in FIG. 1C, may dial to all the customers in the list of customers. The VC 420d may send messages to a media server 450d, such as media server 105b in FIG. 1B for customer to dial. The number of customers is dependent on prevailing dialing ratio and number of customers available for dialing. The VC 420d may wait for the customer to answer the call.

According to some embodiments of the present disclosure, the interface from the media server 450d to the customer 485d may be implemented by Session Initiation Protocol (SIP). The VC 420d and media server 450d may communicate using gRemote Procedure Call (gRPC).

According to some embodiments of the present disclosure, while the VC 420d is dialing to customers, the IntelliDialer 440d, such as IntelliDialer 150c in FIG. 1C, may dynamically generate personalized content tailored to each customer 485d. Each time the 420d VC provides a customers list to IntelliDialer 440d, it uses trained models, available data and LLM AI engine for generating personalized content. The personalized content may be in text-format in a text-file, which may be stored in a database, such as contents-database 155a in FIG. 1A.

According to some embodiments of the present disclosure, the model for the LLM AI engine may be ChatGPT 3.5 Turbo. The trained models may be saved in DB 430d and cached e.g., by using REDIS an open-source in-memory data structure store, that is used as a database, cache, and message broker for fast processing. The AI model that may be implemented is decision tree AI model.

FIG. 4E schematically illustrates a high-level diagram 400E of a computerized-method for providing personalized content for an interaction of an agent with a customer during an outbound conversational marketing campaign of a tenant that is operated via a cloud-based contact center platform, in accordance with some embodiments of the present invention.

According to some embodiments of the present disclosure, under the outbound conversational marketing campaign, an interaction with a customer 485e from a list of customers that has been uploaded to the outbound conversational marketing campaign may be initiated. When the customer 485e is answering the call and the media server 450e sees that there is no agent available, it may inform the VC 420e, such as such as VC dialer 146c in FIG. 1C. The VC 420e may request the IntelliDialer 440e, such as IntelliDialer 150c in FIG. 1C, to provide a personalized content for the customer 485e.

According to some embodiments of the present disclosure, the IntelliDialer 440e may have already generated the personalized content when it received the customers list, so may return the generated personalized content, or alternatively operate the LLM AI engine to generate the personalized content for the customer 485e.

According to some embodiments of the present disclosure, the VC 420e may send the personalized content to the media server 450e to process the media files, such that the text to speech conversion may be performed, and then the personalized content may be played to the customer. The text-file with the related personalized content in text-format may be converted to an audio-format and stored as an audio file in a database, such as contents-database 155a in FIG. 1A. After the initiating of the interaction with the customer and playing the audio-file to the customer 485e, connecting the agent 470e to the interaction when the customer 485e indicates an interest in offerings of the outbound conversational marketing campaign.

According to some embodiments of the present disclosure, the process of checking for an indication if the customer 485e is interested in the offerings of the outbound conversational marketing campaign may be performed by having the VC 420e asking the media server 450e to send the conversation stream to IntelliDialer 440e. The media server 450e may start writing RTP packets to Kafka Topic that scan 490e, such as scan 190c in FIG. 1C, can read. The scan 490e may convert customer speech to text to yield sentiments by using speech recognition 496e, such as speech recognition 196c in FIG. 1C, e.g., Amazon® Transcribe. The sentiments from the speech recognition 496e may be sent to IntelliDialer 440e. Once the agent is connected to the interaction with the customer the sentiment analysis may be required.

According to some embodiments of the present disclosure, the IntelliDialer 440e may store this data in a database for further analysis. The customer speech may be analyzed by the IntelliDialer 440e to check if the customer 485e is showing interest. When the analysis result is that the customer is interested, the IntelliDialer 440e informs the VC 420e and the VC 420e asks the media server 450e to connect the customer 485e to an agent 470e. Once the agent 470e is connected to the customer 485e, the media server 450e informs the VC 420e about the connection. When the agent 470e starts the interaction with the customer 485e, the VC 420e may send the agent 470e the text-filed with the personalized content to a computerized-device of the agent to present the generated personalized content for the interaction in text-format that is in the text-file, via a display unit that is associated to the computerized-device. The generated personalized content for the interaction in text-format may be used by the agent as a guidance during the interaction with the customer to improve engagement of the customer and effectiveness of the outbound conversational marketing campaign.

According to some embodiments of the present disclosure, the personalized content that may be sent from the VC 420e to the IntelliDialer 440e, may be for example,
{
   “Type”: “Get Personalized Pitch”,
   “Campaign Name”: “ABC Credit Card”,
   “Campaign ID”: “aaa-111”,
   “Customer Information”:
   [
      {
         “Name”: “John Deo L”,
         “Phone Number”: “111-222-3333”,
         “Customer ID”: “aaa”
      }
   ]
}

According to some embodiments of the present disclosure, the IntelliDialer 440e may respond as follows:
{
   “Type”: “Get Personalized Pitch Response”,
   “Campaign Name”: “ABC Credit Card”,
   “Campaign ID”: “aaa-111”,
   “Personalized Pitches”:
   [
      {
         “Name”: “John Deo L”,
         “Phone Number”: “111-222-3333”,
         “Customer ID”: “aaa”
         “Pitch”: “Hi John . . . ”
      }
   ]
}

FIG. 4F schematically illustrates a high-level diagram 400F of a computerized-method for providing personalized content for an interaction of an agent with a customer during an outbound conversational marketing campaign of a tenant that is operated via a cloud-based contact center platform, in accordance with some embodiments of the present invention.

According to some embodiments of the present disclosure, the generated personalized content for the interaction in text-format may be used by the agent as a guidance during the interaction with the customer 485f and may allow the agent to be engaged in a meaningful conversation with the customer 485f. The depth of the engagement is enriched by the insights provided by the IntelliDialer 440f, empowering the agent 470f to navigate the conversation with relevance and empathy.

According to some embodiments of the present disclosure, the agent UI, where the personalized content may be displayed, may be developed, for example, by using Javascript/ReactJS. The communication between the agent UI and the VC 420f may be operated for example, via the API, using HTTP Long Poll, WebSocket and the like.

FIG. 4G schematically illustrates a high-level diagram 400G of a computerized-method for providing personalized content for an interaction of an agent with a customer during an outbound conversational marketing campaign of a tenant that is operated via a cloud-based contact center platform, in accordance with some embodiments of the present invention.

According to some embodiments of the present disclosure, after the customer 485g ends the call, the media server 450g may send this event to the VC 420g. The VC 420g may disconnect the agent 470g from the customer 485g and allow agent 470g to enter call disposition. The VC 420g may also send the events to the media server 450g to stop recording the interaction.

According to some embodiments of the present disclosure, after the call ends, the agent 470g may enter call disposition and notes, and may send it to the VC 420g. The VC 420g may generate an Outbound Detail Record (ODR) which includes all information about the call, including disposition, notes, call time etc. The VC 420g may send the ODR to IntelliDialer 440g, such as IntelliDialer 150c in FIG. 1C. The intelliDialer 440g may use the ODR and save the interaction text to be used for the process of fine-tuning of the model the is used by the LLM AI engine, such as LLM AI engine 151c in FIG. 1C.

According to some embodiments of the present disclosure, the process of fine-tuning of the model may be based on data of interactions which were conducted during the outbound conversational marketing campaign. The data may include at least one of: (i) transcriptions of interaction recordings; (ii) dispositions and notes and (iii) transcriptions of interaction recordings along with sentiments which can be used to deduce effectiveness of the interaction.

According to some embodiments of the present disclosure, the ODR may be for example,
Campaign Name: Credit Card Offer
Date: 2023 Nov. 21
Time: 14:30:00
Agent: Sarah Johnson
Contacted Customer: John Deo L

### Customer Information:

Name: John Deo L
Contact Number: (111) 222-3333
Address: USA

### Call Details:

Call Duration: 10 minutes
Call Outcome: Successful

### Discussion Points:

1. Introduced the exclusive credit card offer from XYZ Bank.
2. Highlighted benefits such as cashback, lower interest rates, and a tailored rewards program.
3. Addressed customer inquiries about annual fees and interest rates.
4. Discussed the rewards program and its appeal to the customer.
5. Verified customer information for pre-qualification status check.

### Outcome:

John expressed interest in the credit card offer.
Agreed to further discuss the personalized interest rate after a brief verification process.

### Follow-Up Actions:

Scheduled a follow-up call with John to finalize the application process.
Sent an email with additional details about the credit card offer.

### Notes:

Customer was receptive and engaged throughout the conversation.
Positive sentiment detected in the customer's responses.
No objections or concerns raised by the customer.

According to some embodiments of the present disclosure, once the agent 470g enters disposition and notes into the VC 420g, this information is sent to IntelliDialer 440g. The IntelliDialer 440g may feed this information into the LLM AI engine, such as LLM AI engine 151c in FIG. 1C, to fine-tune it so that future personalized contents are more accurate. The IntelliDialer 440g may also use call recording to further optimize the model the is executed by the LLM AI engine. This loop serves a dual purpose of improving the accuracy of the generated personalized content for subsequent interactions and providing valuable data for evaluation of the outbound conversational marketing campaign.

It should be understood with respect to any flowchart referenced herein that the division of the illustrated method into discrete operations represented by blocks of the flowchart has been selected for convenience and clarity only. Alternative division of the illustrated method into discrete operations is possible with equivalent results. Such alternative division of the illustrated method into discrete operations should be understood as representing other embodiments of the illustrated method.

Similarly, it should be understood that, unless indicated otherwise, the illustrated order of execution of the operations represented by blocks of any flowchart referenced herein has been selected for convenience and clarity only. Operations of the illustrated method may be executed in an alternative order, or concurrently, with equivalent results. Such reordering of operations of the illustrated method should be understood as representing other embodiments of the illustrated method.

Different embodiments are disclosed herein. Features of certain embodiments may be combined with features of other embodiments; thus, certain embodiments may be combinations of features of multiple embodiments. The foregoing description of the embodiments of the disclosure has been presented for the purposes of illustration and description. It is not intended to be exhaustive or to limit the disclosure to the precise form disclosed. It should be appreciated by persons skilled in the art that many modifications, variations, substitutions, changes, and equivalents are possible in light of the above teaching. It is, therefore, to be understood that the appended claims are intended to cover all such modifications and changes as fall within the true spirit of the disclosure.

While certain features of the disclosure have been illustrated and described herein, many modifications, substitutions, changes, and equivalents will now occur to those of ordinary skill in the art. It is, therefore, to be understood that the appended claims are intended to cover all such modifications and changes as fall within the true spirit of the disclosure.

What is claimed:

1. A computerized-method for providing personalized content for an interaction of an agent with a customer during an outbound conversational marketing campaign of a tenant that is operated via a cloud-based contact center platform, said computerized-method comprising:
(i) receiving details of the customer and details of the outbound conversational marketing campaign of the tenant;
(ii) creating a prompt-text based on the received details of the customer and the details of the outbound conversational marketing campaign of the tenant;
(iii) generating the personalized content for the interaction with the customer in text-format by executing a Large Language Model (LLM) Artificial intelligence (AI) engine with a trained model that is stored in a models-database with the created prompt-text;
(iv) storing a text-file with the generated personalized content for the interaction in text-format for the interaction in a contents-database;
(v) initiating the interaction of the agent by dialing to the customer,
wherein the dialing to the customer is performed by operating an Automatic Call Distributor (ACD) software with the details of the customer;
(vi) retrieving the text-file for the interaction from the contents-database; and
(vii) sending the retrieved text-file to a computerized-device of the agent to present the generated personalized content for the interaction in text-format that is in the text-file, via a display unit that is associated to the computerized-device,
wherein the generated personalized content for the interaction in text-format is used by the agent as a guidance during the interaction with the customer to improve engagement of the customer and effectiveness of the outbound conversational marketing campaign.

2. The computerized-method of claim 1, wherein the receiving of details of the customer and the details of the outbound conversational marketing campaign of the tenant is performed by the computerized-method further comprising:
(i) operating a Microservice (MS) for campaign management of the tenant via the cloud-based contact center platform to receive from a user, via a client-device that is associated to a campaign configuration dashboard, data related to the outbound conversational marketing campaign for configuration thereof to be stored in a campaign-database,
wherein the data related to the outbound conversational marketing campaign comprising: (a) customers list allocated for the agent; (b) details of each customer in the customers list; and (c) details of the outbound conversational marketing campaign; and
(ii) configuring the MS for campaign management to operate the outbound conversational marketing campaign, for each customer in the customers list allocated for the agent.

3. The computerized-method of claim 2, wherein the details of the outbound conversational marketing campaign comprising: (i) campaign name; (ii) campaign ID; (iii) campaign type; (iv) campaign offerings; and (v) campaign description, and
wherein the details of each customer in the customers list comprising: (i) customer name; (ii) customer contact details; (iii) social media profiles; (iv) hobbies; (v) address; (vi) age; (vii) monthly salary; and (viii) interests.

4. The computerized-method of claim 1, wherein the creating of the prompt-text comprising embedding in a template-prompt one or more details of the customer and one or more campaigns details to yield the prompt-text.

5. The computerized-method of claim 3, wherein the computerized-method further comprising: training a model for the LLM AI engine to yield the trained model for the LLM AI engine based on: (i) details of the outbound conversational marketing campaign; and (ii) details of each customer in the customers list,
wherein the training is performed by providing: (i) dispositions and notes from Outbound Detail Records (ODR); (ii) details of customers and details of similar outbound conversational marketing campaign to a trained model from the models-database,
and wherein the trained model for the LLM AI engine is stored in the models-database with the outbound conversational marketing campaign details.

6. The computerized-method of claim 1, wherein said computerized-method further comprising: (i) continuously training the trained model for the LLM AI engine during the outbound conversational marketing campaign based on data of interactions which were conducted during the outbound conversational marketing campaign; and (ii) storing the trained model for the LLM AI engine in the models-database.

7. The computerized-method of claim 6, wherein the data of interactions which were conducted during the outbound conversational marketing campaign comprising at least one of: (i) transcriptions of interaction recordings; (ii) dispositions and notes and (iii) transcriptions of interaction recordings along with sentiments which can be used to deduce effectiveness of the interaction.

8. The computerized-method of claim 1, wherein said computerized-method further comprising before the initiating of the interaction with the customer: (i) converting the personalized content in text-format in the text-file to an audio-format; and (ii) storing the converted personalized content in the audio-format as an audio-file in the contents-database.

9. The computerized-method of claim 8, wherein after the initiating of the interaction with the customer, said computerized-method further comprising (i) playing the audio-file to the customer; and (ii) connecting the agent to the interaction when the customer indicates an interest in offerings of the outbound conversational marketing campaign.

10. A computerized-system for providing personalized content for an interaction of an agent with a customer during an outbound conversational marketing campaign of a tenant that is operated via a cloud-based contact center platform, said computerized-system comprising:
one or more processors;
an Automatic Call Distributor (ACD) software associated to the cloud-based contact center platform;
a computerized-device;
a display unit that is associated to the computerized-device;
a models-database, and a contents-database;
a memory to store the plurality of databases; and
a trained model for a Large Language Model (LLM) Artificial intelligence (AI) engine that is stored in a models-database,
said one or more processors are configured to:
(i) receive details of the customer and details of the outbound conversational marketing campaign of the tenant;
(ii) create a prompt-text based on the received details of the customer and campaign details;
(iii) generate the personalized content for the interaction with the customer in text-format by executing the LLM AI engine with the trained model and the created prompt-text;
(iv) store a text-file with the generated personalized content for the interaction in text-format for the interaction in the contents-database;
(v) initiate the interaction for the agent by dialing to the customer,
wherein the dialing to the customer is performed by operating the ACD software with the details of the customer;
(vi) retrieve the text-file for the interaction; and
(vii) send the retrieved text-file to a computerized-device of the agent to present the generated personalized content for the interaction in text-format that is in the text-file, via a display unit that is associated to the computerized-device,
wherein the generated personalized content for the interaction in text-format is used by the agent as a guidance during the interaction with the customer to improve engagement of the customer and effectiveness of the outbound conversational marketing campaign.

11. The computerized-system of claim 10, wherein the details of the customer and details of the outbound conversational marketing campaign of the tenant are received by the computerized-system further comprising:
a Microservice (MS) for campaign management of the tenant;
a campaign-database stored by the memory, and
a campaign configuration dashboard that is connected to the MS for campaign management,
wherein said one or more processors are further configured to:
(i) operate the MS for campaign management of the tenant via the cloud-based contact center platform to receive from a user, via a client-device that is associated to the campaign configuration dashboard, data related to the outbound conversational marketing campaign for configuration thereof to be stored in the campaign-database,
wherein the data related to the outbound conversational marketing campaign comprising: (a) customers list allocated for the agent; (b) details of each customer in the customers list; and (c) details of the outbound conversational marketing campaign; and
(ii) configure the MS for campaign management to operate the outbound conversational marketing campaign, for each customer in the customers list allocated for the agent.

12. The computerized-system of claim 11, wherein the details of the outbound conversational marketing campaign comprising: (i) campaign name; (ii) campaign ID; (iii) campaign type; (iv) campaign offerings; and (v) campaign description, and
wherein the details of each customer in the customers list comprising: (i) customer name; (ii) customer contact details; (iii) social media profiles; (iv) hobbies; (v) address; (vi) age; (vii) monthly salary; and (viii) interests.

13. The computerized-system of claim 10, wherein said one or more processors are configured to create the prompt-text by embedding in a template-prompt one or more details of the customer and one or more campaigns details to yield the prompt-text.

14. The computerized-system of claim 12, wherein said one or more processors are further configured to train a model for the LLM AI engine to yield the trained model for the LLM AI engine based on: (i) details of the outbound conversational marketing campaign; and (ii) details of each customer in the customers list,
wherein the training is performed by providing: (i) dispositions and notes from Outbound Detail Records (ODR); (ii) details of customers and details of similar outbound conversational marketing campaign to a trained model from the models-database,
and, wherein the trained model for the LLM AI engine is stored in a models-database with the outbound conversational marketing campaign details.

15. The computerized-system of claim 10, wherein said one or more processors are configured to: (i) continuously train the trained model for the LLM AI engine during the outbound conversational marketing campaign based on data of interactions which were conducted during the outbound conversational marketing campaign; and (ii) store the trained model for the LLM AI engine in the models-database.

16. The computerized-system of claim 15, wherein the data of interactions which were conducted during the outbound conversational marketing campaign comprising at least one of: (i) transcriptions of interaction recordings; (ii) dispositions and notes; and (iii) transcriptions of interaction recordings along with sentiments which can be used to deduce effectiveness of the interaction.

17. The computerized-system of claim 10, wherein before said one or more processors initiate the interaction with the customer, said one or more processors are further configured to: (i) convert the personalized content in text-format in the text-file to an audio-format; and (ii) store the converted personalized content in the audio-format as an audio-file in the contents-database.

18. The computerized-system of claim 17, wherein after said one or more processors initiate the interaction with the customer, said one or more processors are further configured to: (i) play the audio-file to the customer; and (ii) connect the agent to the interaction when the customer indicates an interest in offerings of the outbound conversational marketing campaign.
